(19) United States
(12) Patent Application Publication
(10) Pub. No.: US 2024/0180175 A1
(43) Pub. Date: Jun. 6, 2024

(54) MACHINE FOR MEAT PROCESSING

(71) Applicant: Mado GmbH, Dornhan (DE)

(72) Inventors: David BEILHARZ, Freudenstadt-Dietersweiler (DE); Valentin Sauter, Epfendorf (DE)

(21) Appl. No.: 18/528,001

(22) Filed: Dec. 4, 2023

(30) Foreign Application Priority Data
Dec. 5, 2022 (DE) 10 2022 132 161.4

(51) Int. Cl. A22C 17/00

(52) U.S. Cl. CPC A22C 17/0026; A22C 17/0093

(57) ABSTRACT

A machine for processing meat includes a motor with a shaft driven by the motor and a receptacle for a meat piece to be processed. The receptacle is open toward the driven shaft so that a part of the meat piece held in the receptacle is fed by an auger arranged in sections on the driven shaft toward a set of blades. The set of blades has a perforated disk arranged essentially perpendicular to the rotational axis of the driven shaft and a blade is arranged on a blade pin and is rotatable with this blade pin in a plane essentially parallel to the perforated disk. The blade pin is arranged on the driven shaft such that rotation of the driven shaft is transferred to the blade pin, so that the blade rotates.

### CROSS-REFERENCE TO RELATED APPLICATIONS

This application claims priority under 35 U.S.C. § 119(b) to German Patent Application No. 10 2022 132 161.4, filed on Dec. 5, 2022, the disclosure of which is incorporated herein by reference in its entirety.

### BACKGROUND OF THE INVENTION

The preferred invention relates to a machine for meat processing with the features described herein. It is especially suitable for an industrial grinder or frozen meat grinder.

Currently, in many cases meat is processed, in particular, ground, in large quantities by machine. For this purpose, pieces of meat or meat blocks, which could also be produced, in particular, by freezing together several pieces of meat, are fed into a receptacle of a machine, which is constructed, for example, as a funnel and which is open toward a shaft driven by a motor, so that the weight of the piece of meat or meat block fed into the receptacle presses against the shaft and especially against at least one blade that has a spiral profile at least in sections around the shaft at least in the area of this receptacle and is connected to the shaft.

The rotation of the shaft produced by the motor has the effect that a strip is cut from the piece of meat or meat block and fed via an auger that is likewise arranged rigidly on the shaft and can also transition into the blade or can have the blade in some sections for further processing in a set of blades.

In addition to one or more stationary perforated disks, this set of blades typically has at least one rotating blade that is connected to a rotatably mounted blade pin. This is connected rotationally locked with the shaft to the motor of the blade pin. Accordingly, the front section of the strip, possibly after processing by a preliminary cutter, is pressed against a perforated disk and cut by the rotating blade, which rotates in a plane lying parallel to the perforated disk, so that the meat is ground. In particular, this process can be repeated multiple times in a set of blades, wherein the holes of the perforated disks typically become smaller successively in the processing direction, that is, in the direction toward the outlet for the ground meat or toward a catch basin arranged or arrangeable on this outlet, so that the meat is ground into increasingly finer pieces.

Known machines of this construction for processing meat, such as, for example, the previous version of the industrial grinder model Mado Gigant MEW 734 made by the applicant, however, suffer the problem that the pieces of meat or meat blocks located in the receptacle produce significant forces on the shaft due to the shear forces during the grinding process due to the cutting and compression at the transition point to the shaft housing and the shaft bends so much that the rotationally locked connection to the blade pin of a set of blades can barely be established and if it can be established, the rotational planes of the blade can easily become misaligned. That is a fatal problem, because these planes typically must be at a small distance and parallel to the perforated disks and a misalignment disrupts this arrangement and consequently results in increased wear in the set of blades or destroys the set of blades.

### BRIEF SUMMARY OF THE INVENTION

The task of the invention is therefore to disclose a machine for processing meat with improved coupling between the shaft and set of blades, in which, in particular, the negative effects resulting from the bending of the shaft is avoided.

This task is achieved by a machine for processing meat with the features of the preferred machine described herein. Advantageous refinements of the invention are the subject matter of the dependent claims.

The machine according to the invention for processing meat has a motor, a shaft driven by the motor, and a receptacle for a piece of meat to be processed or a meat block to be processed. Here, the receptacle is open toward the driven shaft, so that a part of the piece of meat or meat block held in the receptacle is fed by an auger arranged at least in sections on the driven shaft toward a set of blades. This set of blades has at least one perforated disk arranged essentially perpendicular to the rotational axis of the driven shaft and at least one blade arranged on a blade pin and rotatable with this pin in a plane essentially parallel to the at least one perforated disk, and the blade pin is arranged on the driven shaft such that a rotation of the driven shaft is transferred onto the blade pin, so that the blade rotates.

According to the invention, the blade pin is oscillatingly mounted on the driven shaft. This oscillating mounting allows the running of the blade pin to be largely decoupled from the bending moments caused by the loading of the driven shaft due to shear and bending forces, while the rotational movement of the driven shaft continues to be transferred to the blade pin without a problem.

Such an oscillating mounting can be achieved in an especially simple way in that the driven shaft has a pin with side surfaces that are convex at least in sections and extends typically starting from a surface section facing the blade pin along the rotational axis of the driven shaft and engages in a receptacle in the blade pin, so that the rotation of the driven shaft is transferred to the blade pin.

The side surfaces that are convex at least in sections can be formed, for example, by sections of a spherical surface of a ball. For example, the pin can be essentially square-shaped and centered on the rotational axis of the driven shaft: the center point of the ball can then be within the square-shaped pin. In particular, the center point can be on the center axis of the square-shaped pin, wherein the radius of the ball is greater than the distance of the side surfaces of the square-shaped pin from the center axis of the square-shaped pin. For producing the rotationally locked connection, this square-shaped pin can then be inserted into an essentially square-shaped retainer facing it. Other geometric configurations, however, are also conceivable, for example, hexagonal, octagonal, or other polygonal connections.

It is especially preferred if such a retainer of the blade pin has, on its end side facing the driven shaft, walls that have concave sections for holding the convex sections of the side surfaces that are convex at least in sections. Preferably, the curvature of the concave sections is adapted to the curvature of the convex surface sections. This improves the precision of the oscillating mount.

An alternative or additional improvement of the oscillating mount is produced in that the pin has an end surface that is convex at least in sections. If this is the case, the oscillating mount is optimized even more if the base of the retainer also has a concave section for holding the convex section of the end surface that is convex at least in sections, especially if its curvature is adapted preferably to the curvature of the corresponding convex surface section.

Another improvement of the mount can be achieved in that the pin is arranged with side surfaces that are convex at least in sections on the base of a slot that extends starting from the end side of the driven shaft facing the blade pin into the driven shaft such that the retainer is arranged in a head of the blade pin and the head of the blade pin is supported with play in the slot, in order to create the necessary free space for an oscillating movement.

The effects of the deformation of the driven shaft due to the loading on the running behavior of the blade pin can be further reduced in that the blade pin is supported in front of and/or behind at least one perforated disk. In cases in which there are multiple perforated disks, this condition is also obviously fulfilled when there is only one perforated disk for which this applies. It is especially advantageous, however, if the blade pin in the preliminary cutter is arranged in front of all the other perforated disks seen in the processing direction of the meat and mounted in a crossing brace that is arranged behind all the other perforated disks in the processing direction of the meat.

The realization of this mounting with roller bearings has proven especially effective.

In addition, the area of the oscillating movement can also be sealed by sealing elements made, for example, from rubber.

To prevent too much wear during components during the resulting oscillating movements, these components or their relevant surfaces are hardened and/or tempered.

### BRIEF DESCRIPTION OF THE SEVERAL VIEWS OF THE DRAWING

The foregoing summary, as well as the following detailed description of the preferred invention, will be better understood when read in conjunction with the appended drawings. For the purpose of illustrating the preferred invention, there are shown in the drawings embodiments which are presently preferred. It should be understood, however, that the invention is not limited to the precise arrangements and instrumentalities shown. In the drawings:

FIG. 1 is a cross section through a machine for processing meat,

FIG. 2 is an enlarged cross-sectional view of the shaft and set of blades of the machine for processing meat from FIG. 1,

FIG. 3 is an individual view of the shaft and blade pin of the machine for processing meat from FIG. 1,

FIG. 4a is a view of the connecting section of the shaft to the blade pin, seen at an angle from the front,

FIG. 4b is a view of the connecting section of the blade pin to the shaft, seen at an angle from the front,

FIG. 5 is a detail enlargement of a part of the connecting section between the shaft and blade pin in cross section, and

FIG. 6 is an external view of the machine for processing meat from FIG. 1.

### DETAILED DESCRIPTION OF THE INVENTION

Unless otherwise indicated, the same reference symbols are used for equivalent embodiments. For better clarity, not every reference symbol is included in every figure.

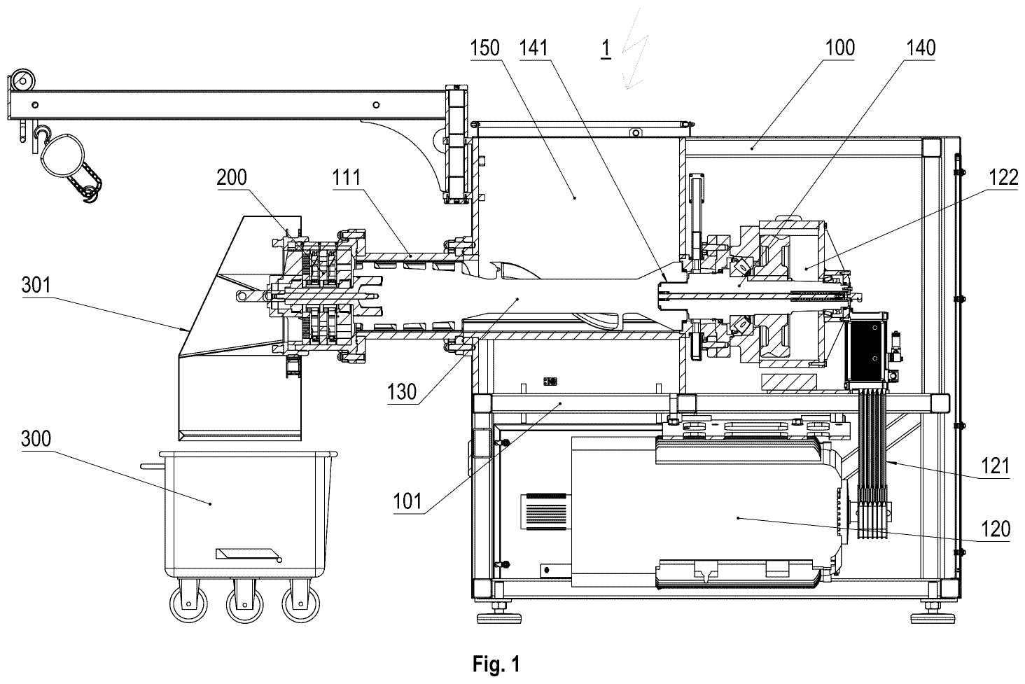

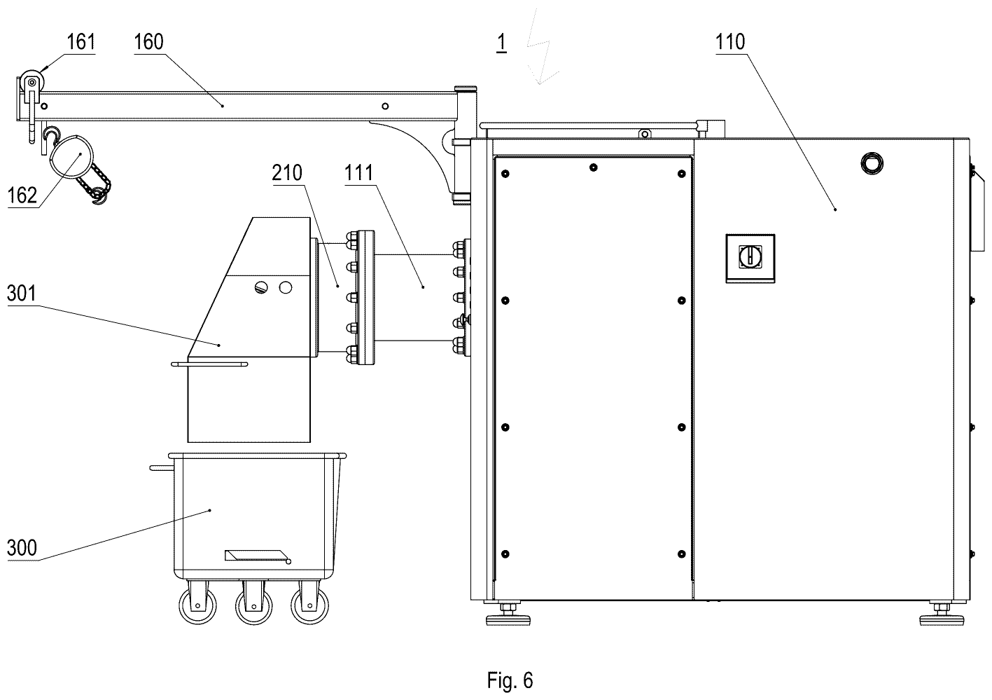

The machine 1 shown in FIG. 6 for processing meat has, as can be seen best in the cross-sectional view of FIG. 1, a machine frame 100, which defines an interior space. The interior space is separated from the environment by a housing 110 that is supported by the machine frame 100 and can be seen best in FIG. 6.

In the interior space of the machine frame 100 there is a motor 120, typically an electric motor, which is arranged, in this embodiment, close to the base in the lower area of the machine frame 100. The motor 120 is used to put a shaft 130 in rotation, which will be described in even more detail below. For this purpose, the shaft 130 is connected rotationally locked with a shaft retainer 140, which is put in rotation about a rotational axis that ideally coincides with a center axis of the shaft 130 by the motor 120 in this embodiment via a belt drive 121 and a gear mechanism 122, and thus is a driven shaft 130. The rotationally locked connection between the driven shaft 130 and the shaft retainer 140 is produced in this example by a positive-fit connection between a projection 141 of the shaft retainer that engages in a recess 139 of the driven shaft 130.

In addition, the shaft retainer 140 has a hydraulically operated push rod 141, which can loosen the rotationally locked connection between the shaft 130 and shaft retainer 140 by an axial displacement of the push rod 141 in the direction parallel to the rotational axis on the end of the shaft 130 facing away from the shaft retainer 140 and simplifies the disassembly of the shaft, for example, for cleaning after a processing operation. The shaft retainer 140 and the shaft held therein are supported on an intermediate base 101 of the machine frame 100 arranged above the motor 120.

Similarly, the arm 160, which is arranged on the end side and preferably pivotable in the upper area of the machine frame 100 with hoist gear 162 that can be moved with a rotor 161 along the arm 160, is used for supporting the assembly and disassembly of the shaft 130, which is frequently performed especially for hygienic reasons.

Starting from the shaft retainer 140, the shaft 130 extends through a receptacle 150 that is constructed as a funnel open toward the top into a tubular shaft housing 111, which connects to the housing 110 on the end side. A set of blades 200, which is described in more detail below; is attached to its housing 210 for the set of blades on the tubular shaft housing 111 on its end facing away from the housing 110. The end of the housing 210 for the set of blades facing away from the tubular shaft housing 111 carries a catch basin 300 with a protective hood 301.

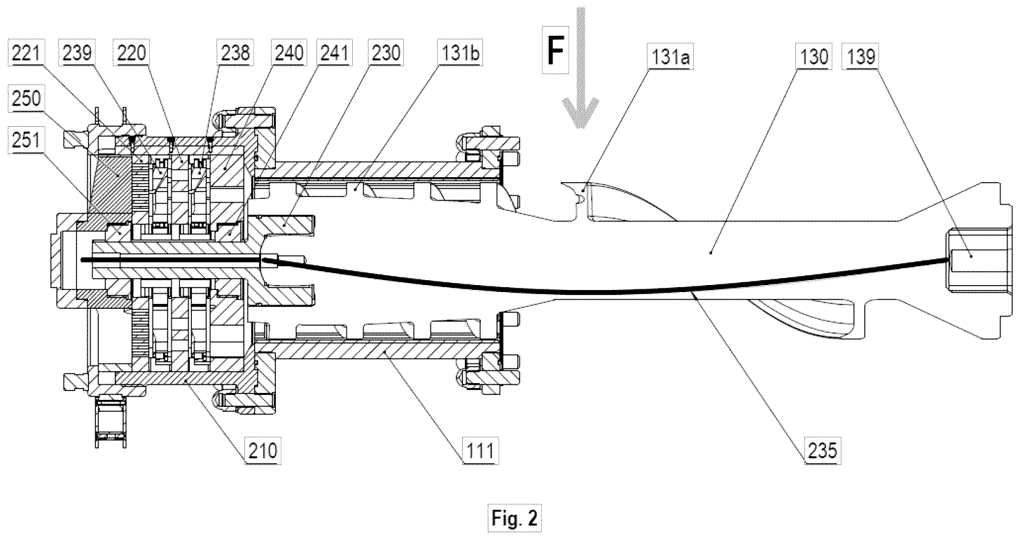

Accordingly, a piece of meat to be processed or a meat block to be processed, which can consist, for example, of frozen-together pieces of meat, can be introduced from above into the receptacle 150 constructed as a funnel, for example, by means of a not-shown conveyor belt, from whose end it falls into the receptacle 150. Because the receptacle 150 is open toward the driven shaft 130, the piece of meat to be processed or a meat block to be processed comes in contact with the driven shaft 130 and should be gradually fed by this with the help of an auger 131 arranged on the driven shaft 130 to the set of blades 200 for grinding processing. How this happens in detail can be seen in the cross-sectional representation of FIG. 2.

In this embodiment, the auger 131 has two sections 131a and 131b, in which it is constructed differently. The section 131a of the auger 131, which lies in the receptacle 150, has a relatively high inclination and circles the driven shaft 130 once within the receptacle and is provided with a blade, so that meat can be cut by the section 131a of the auger 131 from a meat block located in the receptacle 150. The section 131b of the auger arranged in the tubular shaft housing 111 has a flatter inclination, winds several times around the driven shaft 130, and allows only a small gap to the inside of the tubular shaft housing 110, so that the pieces of meat cut by the first section 131a can be pressed in the direction toward the set of blades 200, which happens from the front toward the back. In the description of the set of blades 200, the side facing the receptacle 150 is designated as the front side.

The set of blades 200 has, as already mentioned, a housing 210 for the set of blades, which is constructed essentially with a cylindrical, tubular shape. In the interior of the housing for the set of blades there are two perforated disks 220, 221, whose diameters are each adapted to the inner diameter of the housing 210 for the set of blades, arranged essentially perpendicular to the rotational axis of the driven shaft 130. In this way, the center of the perforated disks 220, 221 passes from a blade pin 230 supported in front of the front perforated disk 220 in the preliminary cutter 240 and behind the rear perforated disk 221 in the crossing brace 250 and rotatably mounted by bearings 241, 251, which carries two blades 238, 239, so that the blades 238, 239 circle in front of the perforated disk 220s and 221, respectively, when the blade pin is rotating and the meat is further ground by the cutting of the sections of meat pressed at this time into holes of the perforated disks 220 and 221. Because the auger 131 feeds additional meat sections into the interior of the set of blades 200, the meat sections are pressed through the holes of the perforated disks 220, 221 and finally land, ground, in the catch basin 300.

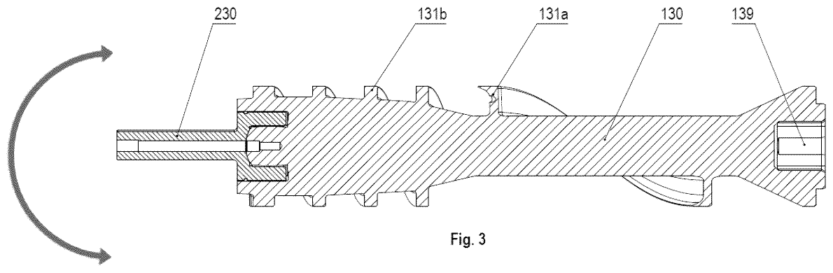

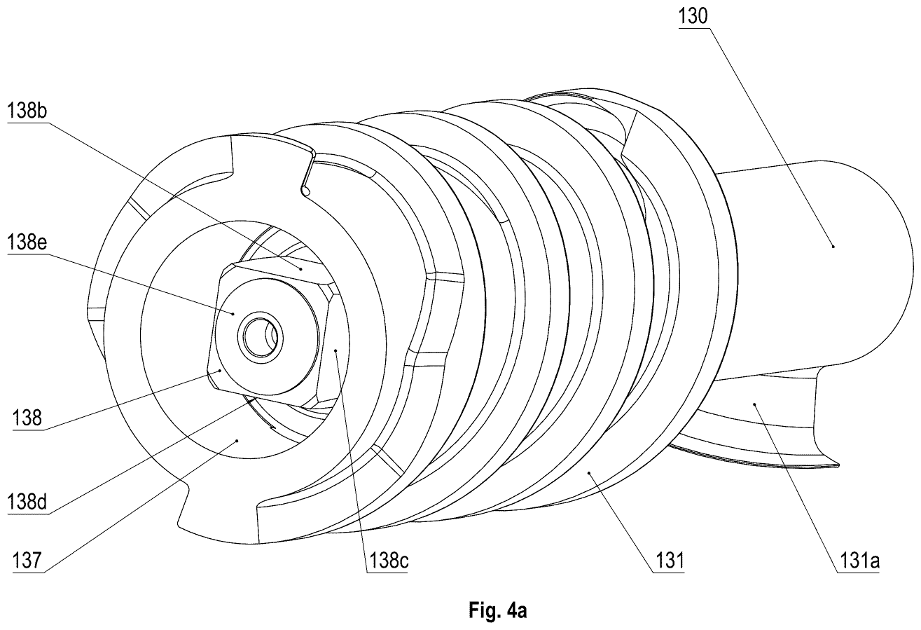

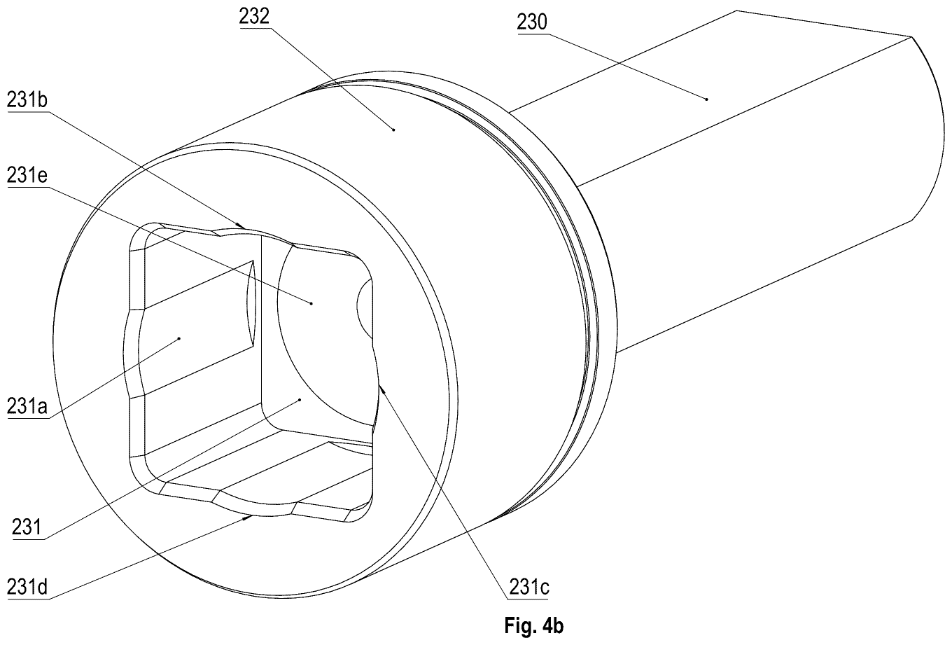

In FIG. 2, for illustration of the problem solved by the invention, the force F acting on the driven shaft 130 and—exaggerated for the sake of illustration—a center line 235 of the driven shaft 130 deformed by the effect of the force F, which would be transferred for an accurately fitting, rotationally locked connection of the blade pin 230 with the driven shaft 130 onto the blade pin 230 and thus the set of blades 200 would be loaded. This is prevented by the oscillating support of the blade pin 130 in the driven shaft 130 shown by the arrow in FIG. 3, which can be realized especially in the way shown in FIGS. 4a,4b, and 5.

As the view of the connecting section of the shaft 130 shown in FIG. 4a to the blade pin 230 shows, the driven shaft 130 has an essentially square-shaped pin 138 centered on the rotational axis of the driven shaft 130 with convex side surface sections 138a, 138b, 138c, 138d on the side surfaces of the essentially square-shaped pin 138. In addition, the essentially square-shaped pin 138 centered on the rotational axis of the driven shaft 130 has a convex end surface section 138e.

Here, the essentially square-shaped pin 138 centered on the rotational axis of the driven shaft 130 with side surfaces that are convex at least in sections is arranged at the base of a slot 137 that extends starting from the end side of the driven shaft 130 facing the blade pin 230 into the driven shaft 130.

In the view shown in FIG. 4b of the connecting section of the blade pin 230 to the shaft 130, it can be seen that the blade pin 230 has, on its end side facing the driven shaft, a retainer 231 for the essentially square-shaped pin 138 centered on the rotational axis of the driven shaft 130 with convex side-surface sections 138a, 138b, 138c, 138d, wherein the walls of the retainer have concave sections 231a, 231b, 231c, 231d for holding the convex side-surface sections 138a, 138b, 138c, 138d.

In addition, the base of the retainer 231 also has a concave section 231e for holding the convex end surface 138e.

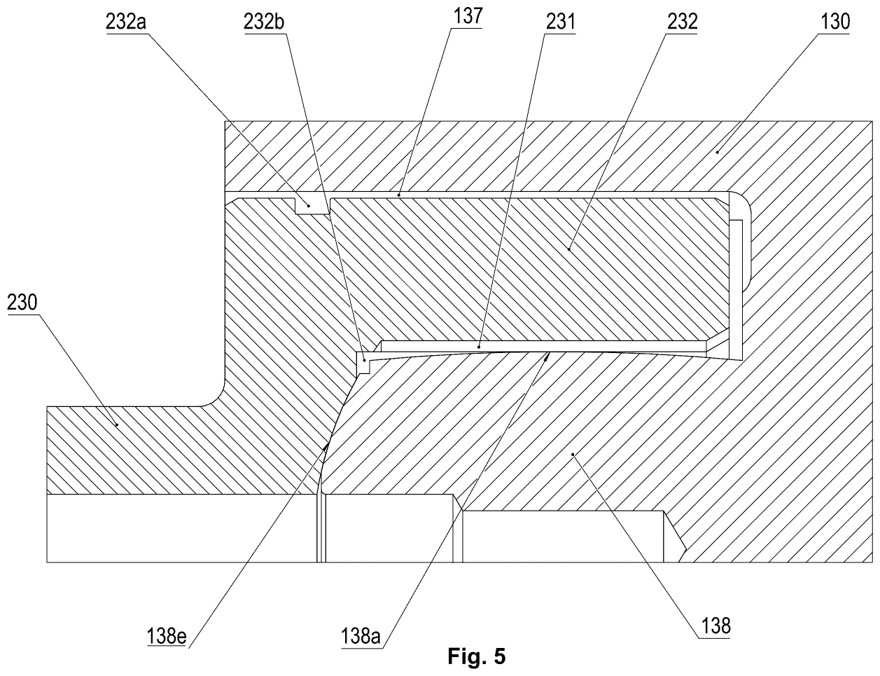

As the detail enlargement shown in FIG. 5 in cross section of a part of the connecting section between the driven shaft 130 and blade pin 230 shows, the retainer 231 is arranged in a head 232 of the blade pin 230 and the head 232 is mounted with play in the slot 137, in order to allow oscillating movement. To prevent metal from rubbing on metal in the event of oscillating movements, damping elements made, for example, from rubber can also be provided in grooves 232a, 232b on the head 232 and/or on the pin 138.

In addition, the area of the oscillating movement can also be sealed by sealing elements made, for example, from rubber.

To prevent too much wear between components in the event of oscillating movements, these components or their affected surfaces can be hardened and/or tempered.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

### LIST OF REFERENCE SYMBOLS

1 Machine
100 Machine frame
101 Intermediate base
110 Housing
111 Shaft housing
120 Motor
121 Belt drive
122 Gear mechanism
130 Shaft
131 Auger
131a Section
131b Section
137 Slot
138 Pin
138a-d Convex side surface section
138e Convex side surface section
139 Recess
140 Shaft retainer
141 Projection
150 Receptacle
160 Arm
161 Rotor
162 Hoist gear
200 Set of blades
210 Housing for the set of blades
220 Perforated disk
221 Perforated disk
230 Blade pin
231 Retainer
231a-d Concave section
231e Concave section
232 Head
232a Groove
232b Groove
235 Center line
238 Blade
239 Blade
240 Preliminary cutter
241 Bearing
250 Crossing brace
251 Bearing
300 Catch basin
301 Protective hood
F Force

1-7. (canceled)

8. A machine for processing meat comprising:
a motor with a driven shaft that is driven by the motor and with a receptacle for a meat piece to be processed or a meat block to be processed, the receptacle is open toward the driven shaft so that a part of the meat piece or meat block held in the receptacle is fed by an auger arranged at least in sections on the driven shaft toward a set of blades, the set of blades has at least one perforated disk arranged generally perpendicular to a rotational axis of the driven shaft and a blade arranged on a blade pin and rotatable with the blade pin in a plane lying essentially parallel to the at least one perforated disk, the blade pin is arranged on the driven shaft such that a rotation of the driven shaft is transmitted to the blade pin so that the blade rotates and the blade pin is oscillatingly supported on the driven shaft.

9. The machine according to claim 8, wherein the driven shaft has a pin with side surfaces that are convex at least in sections.

10. The machine according to claim 9, wherein the pin is constructed with a polygonal connection.

11. The machine according to claim 10, wherein the polygonal connection is square-shaped, hexagonal, octagonal, or provided with some other polygonal connection, the polygonal connection being centered on the rotational axis of the driven shaft.

12. The machine according to claim 9, wherein the blade pin has, on an end side facing the driven shaft, a retainer for the pin with the side surfaces that are convex at least in sections, wherein walls of the retainer have concave sections for holding the convex at least in sections of the side surfaces of the pin.

13. The machine according to claim 12, wherein the pin has an end surface with a convex section.

14. The machine according to claim 13, wherein a base of the retainer has a concave section for holding the convex section of the end surface that is convex at least in sections.

15. The machine according to claim 12, wherein the pin with side surfaces that are convex at least in some sections is arranged at a base of a slot, which extends starting from an end side of the driven shaft facing the blade pin into the driven shaft so that the retainer is arranged in a head of the blade pin and the head of the blade pin is supported with play in the slot.

16. The machine according to claim 8, wherein the blade pin is supported one of in front of and behind the at least one perforated disk.
